(19) United States
(12) Patent Application Publication
(10) Pub. No.: US 2007/0143136 A1
(43) Pub. Date: Jun. 21, 2007

(54) Handling radiology orders in a computerized environment

(75) Inventors: John Lee Moore III, Independence, MO (US); Joshua Davis, Kansas City, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: Cerner Innovation, Inc., Overland Park, KS (US)

(21) Appl. No.: 11/303,662

(22) Filed: Dec. 16, 2005

(51) Int. Cl. G06Q 10/00; G05B 19/418

(52) U.S. Cl. 705/2; 705/8

(57) ABSTRACT

Computerized methods, systems, and user interfaces for handling one or more radiology orders are provided. Such methods, systems, and user interfaces allow a radiologist, radiological technician, or other healthcare professional to efficiently review and approve, modify, or reject electronic requests from ordering physicians to have patients undergo radiological examination. Such methods, systems, and user interfaces also allow regulators to audit the radiology vetting process to ensure that proper review of radiological examination requests is being conducted. Computerized methods, systems, and user interfaces for automatic electronic notification of ordering physicians of modified or cancelled radiological examination requests are also provided.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of computer software. More particularly, the present invention relates to computerized systems and methods for handling radiological examination requests from physicians, which must be evaluated and then approved, modified, or rejected by a radiologist, radiographer, or other healthcare professional specializing in radiology.

### BACKGROUND OF THE INVENTION

In the course of treating patients, physicians frequently request that patients undergo radiological examinations for diagnostic and treatment purposes. Health care regulations in certain countries (e.g., United Kingdom, Ireland, Canada) require that these physician-ordered radiological examination requests be reviewed and approved by a radiologist or other radiology professional before patients can be exposed to radiation. This review process is often called “vetting.” Additionally, certain countries have limited radiological imaging resources. Due to this resource limitation, the resources must be allocated by a radiology professional to ensure fair access on an as-needed basis. Regulators perform audits to determine whether this approval process is being conducted properly and whether radiological resources are being properly allocated. Currently, the vetting process is performed manually in a paper-based format. This paper-based format results in inefficiencies and possibly even errors that threaten patient safety. A computerized process for handling radiological examination requests is needed to increase efficiency, enhance patient safety, and provide an auditable trail for health care regulators and health insurance providers.

Even in countries without such review and approval regulatory requirements (e.g., United States), concerns surrounding cost-containment and reimbursement create a need for a computerized method of handling radiological examination requests. An electronic format would enable the radiology professional to quickly and accurately determine whether the proposed examination is justified in the context of the reason provided and the patient history. Since health insurers typically only reimburse for medical treatment deemed necessary, the likelihood of reimbursement for radiological examinations would improve.

In a typical radiology vetting process, after a treating physician requests that a patient undergo a radiological examination, a radiologist reviews the stated reason for the exam and the patient history to determine whether the requested examination is clinically appropriate (hereinafter, the term “radiologist” shall be deemed to include physicians specializing in radiology as well as radiographers, technologists, and other technicians who specialize in radiological techniques). If the radiologist deems the examination to be appropriate and properly justified, the radiologist will approve the request and provide a scheduling window to scheduling personnel. If the radiologist deems the examination to be inappropriate or not properly justified, the radiologist will reject or modify the request, and notify the ordering party of the reason for the rejection. This process is currently inefficient, time consuming, and not easily tracked. A computer-implemented process to support, expedite, document, and improve this vetting process is needed.

### BRIEF SUMMARY OF THE INVENTION

Embodiments of the present invention relate to computer-implemented methods for handling radiology orders received from ordering physicians or other healthcare professionals. The process includes receipt of a request that a patient undergo a radiological examination. A determination is then made as to whether the request is one that must undergo an approval process by a radiologist. The request is then handled accordingly. For requests requiring approval, the method further includes receiving a vetting command from the radiologist and performing an appropriate responsive process based on the command. One example responsive process is the receipt of scheduling information, upon approval of an order, which is then transmitted to a scheduler.

Yet another type of command that can be received from the radiologist is the replacement of an order by a different order. In such a case, the method further includes receiving scheduling information for the new order and automatically notifying the ordering physician of the replaced order.

In other instances, the method accommodates handling a radiology order to be approved and supplemented with an additional radiology order. In such a case, the method further includes receiving a command to supplement the selected order with an additional order, receiving scheduling information for the original and additional orders, and automatically notifying the ordering physician of the additional order.

In another embodiment, the method accommodates the rejection of a radiology order. In such a case, the method further includes receiving a command to cancel the selected radiology order, receiving a reason for the cancellation, and automatically notifying the ordering physician of the cancelled order.

Other embodiments relate to computerized systems for handling radiology orders. In one embodiment, a computerized system is provided that includes an order receiving component, a storage component for storing unapproved orders, a vetting selection receiving component, a processing component, and a storage component operative to store vetting histories. The order receiving component receives incoming radiology orders from ordering physicians. The first storage component stores unapproved radiology orders in a vetting queue. The vetting selection receiving component receives a vetting command from the user. The processing component performs a responsive process based on the vetting command received. And, the second storage component stores an archive of all radiology orders accompanied by details indicative of vetting actions taken on those orders.

Another aspect of the present invention relates to a user interface embodied on one or more computer readable media. The user interface represents data to a user. The user interface comprises a display area for at least one radiology order occurrence, at least one display area for details associated with that occurrence, and for each order occurrence, a display area indicative of that order's vetting status.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a flow diagram showing a method for handling radiology orders received from an ordering physician or other healthcare professional;

FIG. 3 is a flow diagram showing a method for handling an approved radiology order and performing a responsive process;

FIG. 4 is a flow diagram showing a method for handling a replacement radiology order and performing a responsive process;

FIG. 5 is a flow diagram showing a method for handling an original radiology order and one or more additional radiology orders and performing a responsive process;

FIG. 6 is a flow diagram showing a method for handling a rejected radiology order and performing a responsive process;

FIG. 7 is a screen display of an exemplary interactive view for displaying radiology orders and receiving vetting selections in accordance with embodiments of the present invention;

FIG. 8 is a screen display of an exemplary interactive view for displaying vetting action notifications pertaining to radiology orders by means of electronic mail; and

FIG. 9 is a screen display of an exemplary interactive view for displaying the contents of an electronic message containing details associated with vetting actions taken on a particular radiology order.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide computerized methods, systems and user interfaces for receiving and handling radiological orders to be approved, modified, or rejected by a radiologist. Embodiments of the present invention further provide computerized methods and systems for receipt of scheduling timeframes for approved radiological procedures and automated notification of a requesting physician where appropriate. An exemplary operating environment is described below.

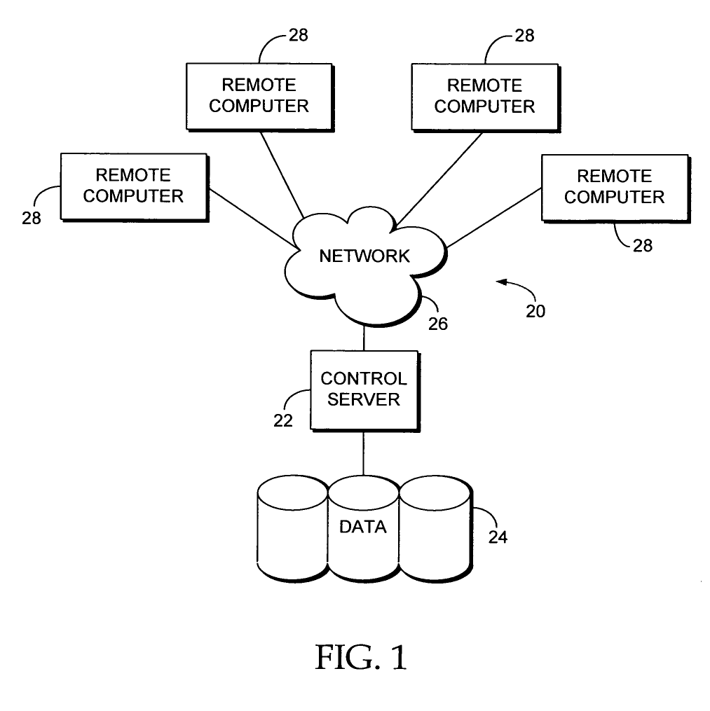

Referring to the drawings in general, and initially to FIG. 1 in particular, an exemplary computing system environment, for instance, a medical information computing system, on which the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer readable media, for instance, database cluster 24. Computer readable media can be any available media that may be accessed by control server 22, and includes volatile and nonvolatile media, as well as removable and nonremovable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage device, or any other medium which can be used to store the desired information and which may be accessed by control server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for control server 22. For example, the database cluster 24 can contain client-defined instructions regarding whether particular radiology orders are of the type that require approval and whether they require reserving radiological resources for a sufficient time so as to be “schedulable.” The database cluster 24 can also contain an archive of radiology orders, which includes, for example, for each radiology order occurrence, details associated with the occurrence such as patient and physician identity, the type of radiological examination requested, a date and time stamp, the vetting action taken by the radiologist or healthcare professional, and other information related to the radiology order. This archive, stored in database cluster 24, can be used by regulators, administrators, insurers, and others to review the radiology order evaluation and approval process.

The control server 22 may operate in a computer network 26 using logical connections to one or more remote computers 28. Remote computers 28 may be located at a variety of locations in a medical environment, for example, but not limited to, clinical laboratories, hospitals and other inpatient settings, ambulatory settings, medical billing and financial offices, hospital administration settings, home health care environments, and clinicians' offices. Clinicians may include, but are not limited to, a treating physician or physicians, specialists such as surgeons, radiologists and cardiologists, emergency medical technicians, physicians' assistants, nurse practitioners, nurses, nurses' aides, pharmacists, dieticians, microbiologists, and the like. Remote computers 28 may also be physically located in non-traditional medical care environments so that the entire health care community may be capable of integration on the network. Remote computers 28 may be personal computers, servers, routers, network PCs, peer devices, other common network nodes, or the like, and may include some or all of the elements described above in relation to the control server 22.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or all of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. The control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare orders. As contemplated by the language above, the methods and systems of embodiments of the present invention may also be implemented on a stand-alone desktop, personal computer, or any other computing device used in a healthcare environment or any of a number of other locations.

As mentioned above, the invention provides computerized systems, methods and user interfaces for handling radiology requests submitted by treating physicians or other healthcare professionals. More particularly, the invention provides computerized systems, methods, and user interfaces for handling radiology requests that must be approved by a radiologist, other physician specializing in radiology, radiographer, technologist, or other technician specializing in radiological techniques. Hereinafter, “radiologist” shall be deemed to include any of these individuals. Radiology requests are orders placed by physicians or other appropriate healthcare professionals who wish to have their patients undergo examination through one or more radiological techniques, usually for diagnostic purposes. Hereinafter, “ordering physician” shall be deemed to include any such individuals who submit radiology orders. A healthcare professional may be a physician, nurse, or any person who provides healthcare services to patients. Radiological techniques may be, by way of example and not limitation, radiography (X-ray, etc.), magnetic resonance imaging (MRI), ultrasound, computed tomography (CT), and nuclear imaging. And, the approval required may be for regulatory, safety, insurance, audit, cost-monitoring, record-keeping, or other clinical, financial, operational, or administrative purposes. From a regulatory standpoint, for example, regulators can audit the records of completed radiological procedures and determine whether the vetting process was conducted appropriately, identify the individual that approved the particular procedure, and review the reason for conducting the procedure. From a safety standpoint, for example, the radiographer or other radiological technician performing the examination will not be able to access the radiology order and complete it unless it has been approved through the vetting process. And from an insurance standpoint, for example, the insurer will be able to determine whether the particular radiological procedure was deemed clinically justified and make coverage decisions accordingly.

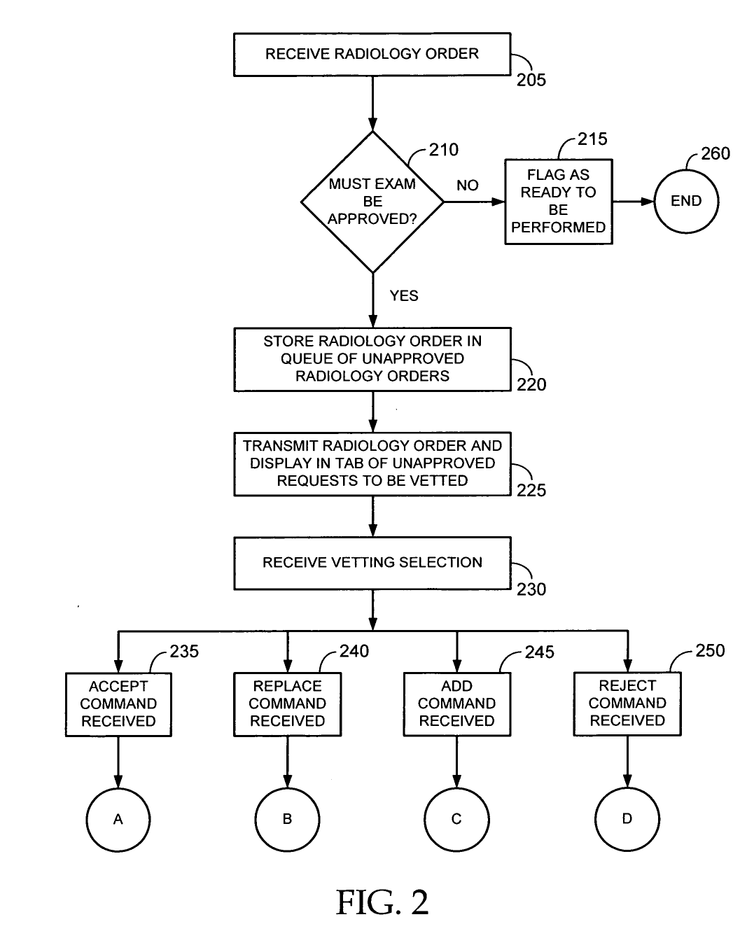

FIG. 2, an exemplary embodiment of the invention, displays a method 200 for handling radiology orders submitted by an ordering physician or other healthcare professional. In a step 205, a radiology order is received by the computer system from an ordering physician. The order is initially flagged as not ready for scheduling because it has not yet been processed by the system. A radiology order from an ordering physician typically includes details such as patient identification information, physician identification information, patient classification information, the type of radiological procedure requested, a time and date stamp, a reason for the procedure, other comments, and other information relevant to the radiology order. In a step 210, the computer system compares the type of submitted radiology order to a configurable client-defined database of radiology order types that must be approved before they can be performed. If the submitted order is not of a type which must be approved, then, in a step 215, the order is flagged as not requiring approval and flagged as ready to be performed. In a step 260, the process ends for an order flagged as not requiring approval. When the radiologist attempts to complete the order, she will not be prevented from starting because the order is now flagged as ready to be performed.

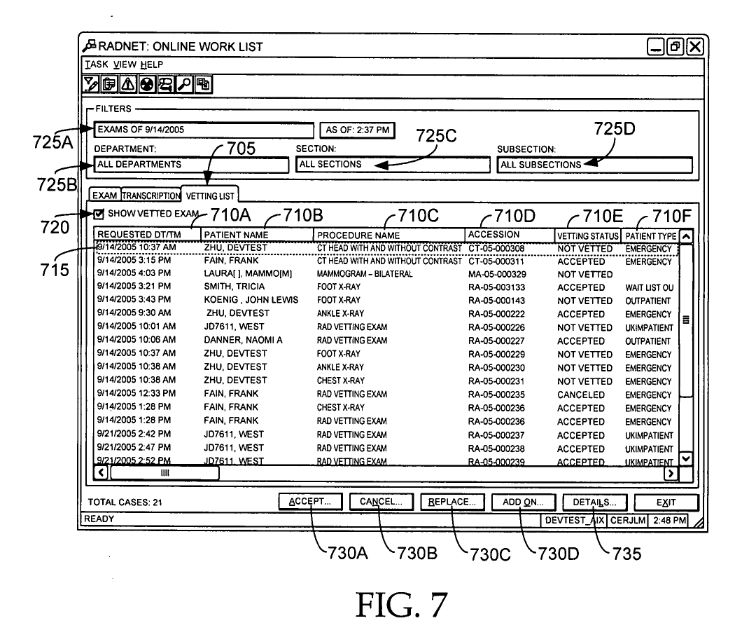

If the submitted order is of a type which must be approved, then, in a step 220, the order is maintained as an unapproved order and stored in a queue of unapproved radiology orders. In a step 225, the radiology order is transmitted and displayed to a radiologist or other healthcare professional that reviews and then approves, modifies, or rejects radiology orders. Radiology orders are displayed using an exemplary user interface 700, as depicted in FIG. 7, which is an illustrative screen display of the radiology vetting queue and is discussed in further detail below. At this point, the radiologist will review the radiology order using information such as the patient history, the procedure requested, and the reasoning provided by the ordering physician to determine whether the order should be approved, rejected, or modified. In a step 230, a vetting selection is received from the user, in this case, the radiologist. The user may choose to approve the order, to reject the order, or to modify the order. Possible modifications include, by way of example and not limitation, adding on one or more additional radiological procedures or replacing the requested procedure with one or more different procedures. In this particular embodiment, possible vetting selections corresponding to these actions include “accept,” “cancel,” “replace,” and “add on.”

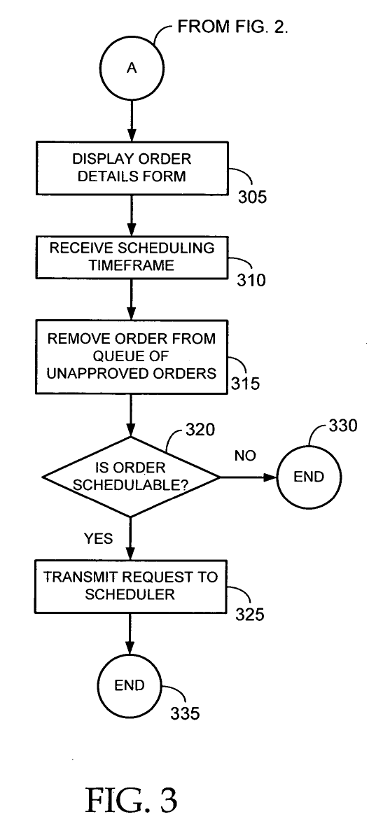

In a step 235, if the radiologist enters an “accept” vetting selection, a command to accept a radiology order is received, the radiology order is flagged as approved, and a responsive process 300 is performed, as depicted in FIG. 3. The responsive process 300 is unique to the “accept” vetting selection in this embodiment. In a step 305, the details corresponding to the accepted radiology order are displayed to the user, which, in this embodiment, is the radiologist or other healthcare professional charged with reviewing radiology orders. The details can include patient identifying information, ordering physician identifying information, the type of procedure requested, reasons for the procedure, a time and date stamp, and other information relevant to the radiology order. The radiologist can then determine the urgency of the particular radiological procedure and prioritize it against other pending radiology orders. In a step 310, a scheduling window is received from the radiologist that designates a timeframe within which the radiological examination is to occur. For example, the radiologist may determine that the procedure is not urgent and schedule the exam to occur within a two week window commencing one month from the date of approval. In the alternative, the order may be given a definite appointment time. In a step 315, the radiology order is removed from the queue of unapproved radiology orders. In a step 320, the computer system determines whether the order is of a type that is schedulable by comparing the order type to a configurable client-defined database of schedulable orders. If the order is not schedulable, then the process ends in a step 330 and the approved procedure can be carried out. The order may not be schedulable, for example, because it is a relatively simple radiological procedure, which does not require allotting a block of time on the applicable radiological resources. If the order is schedulable, then, in a step 325, the approved radiology order is flagged as ready for scheduling and transmitted to a scheduler to schedule the time and date for the examination. Scheduling may be done using functionality provided by commercially available scheduling programs such as the Scheduling Management solution offered by the Cerner Corporation of Kansas City, Mo. In a step 335, the process ends and the user may address other pending radiology orders. After an order has been flagged as approved, the order can be completed by a radiographer, radiological technician, or other healthcare professional responsible for carrying out radiological procedures. The system will prevent orders that have not been flagged as approved from being carried out.

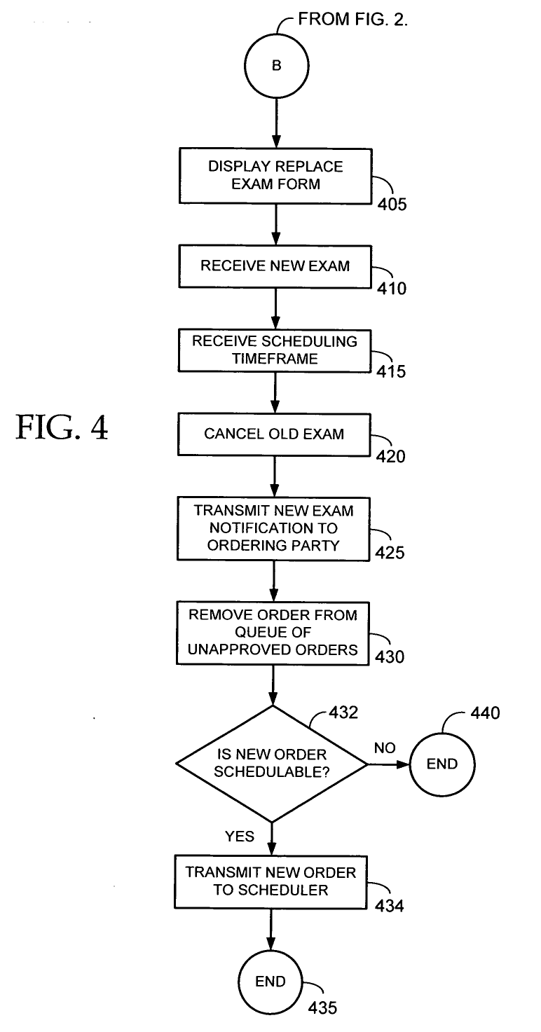

In a step 240, if the user enters a “replace” vetting selection, a command to replace the existing radiology order with one or more new orders is received and a responsive process 400 is performed, as depicted in FIG. 4. The responsive process 400 is unique to the “replace” vetting selection in this embodiment. In a step 405, details corresponding to the selected order are displayed and the radiologist is prompted to enter one or more replacement orders accompanied by new exam details. For example, a radiologist may receive an order requesting a CT scan of the patient's abdomen, but the radiologist determines that an X-ray of the patient's chest would be more clinically appropriate under the circumstances and may decide to replace the existing order. In this example, the radiologist can then enter this new order for the chest X-ray. In a step 410, a new radiology order is received, stored in the vetting queue, flagged as having a vetting status of approved, and flagged as ready for scheduling. The new radiology order can contain the same type of details, such as patient identification, ordering physician identification, type of procedure, date and time stamp, a reason for the procedure, etc. Exam details can be copied over from the original exam. For example, the patient identification information, can be automatically copied over so the radiologist will not have to re-enter the identifying information.

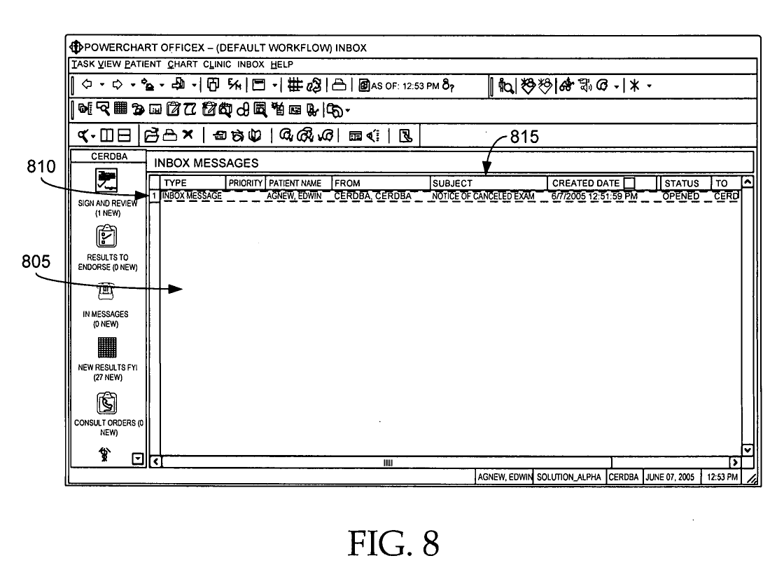

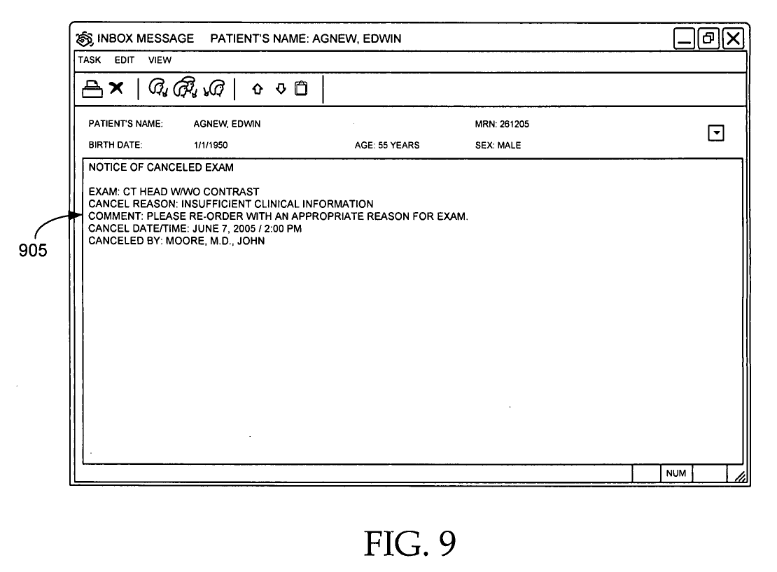

After the replacement order is received in a step 410, the system prompts the user for a scheduling timeframe and receives a scheduling window or definite appointment time in a step 415. In a step 420, the original order is flagged as having been cancelled. In a step 425, the system automatically transmits a notification to the physician who ordered the examination. The notification can take the form of an electronic mail message, for example, that is transmitted to the physician's inbox in an electronic healthcare system. As discussed in detail below, FIGS. 8-9 display exemplary user interfaces for such an electronic notification of a cancelled radiology order. The notification could be by other electronic means, such as through a portable wireless communication device. The contents of the electronic notification can include the fact that the original order has been cancelled and replaced by a new order. The notification can also include details associated with the cancelled order, such as patient identification information, the type of radiological procedure requested, a date and time stamp indicative of when the order was cancelled, identification of the radiologist who cancelled the order, a reason for canceling the order, and other comments associated with the vetting action taken. In a step 430, the original order, which has been cancelled, is removed from the queue of unapproved-orders. In a step 432, the computer system determines whether the new replacement order is of a type that is schedulable by comparing the order type to a configurable client-defined database of schedulable orders. If the new order is not schedulable, then the process ends in a step 440 and the replacement procedure can be carried out. The order may not be schedulable, for example, because it is a relatively simple radiological procedure, which does not require allotting a block of time on the applicable radiological resources. If the order is schedulable, then, in a step 434, the approved radiology order is flagged as ready for scheduling and transmitted to a scheduler. Upon receipt of the automatic notification, the ordering physician may still cancel any replacement orders, but if the ordering physician takes no action, any replacement orders received from the radiologist can be carried out. In a step 435, the process ends and the user may address other pending radiology orders.

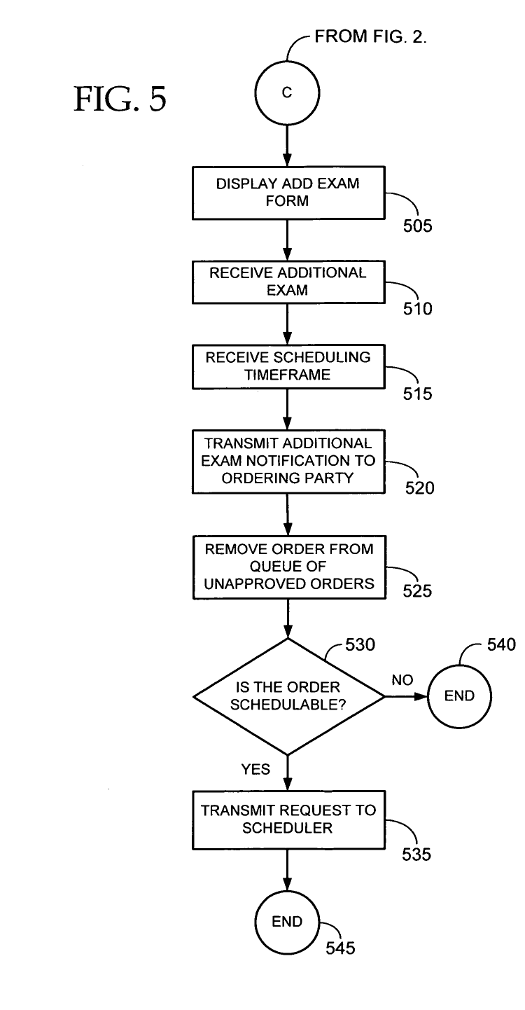

In a step 245, if the user enters an “add on” vetting selection, a command to add an additional radiology order is received, the original radiology order is flagged as approved, and a responsive process 500 is performed, as depicted in FIG. 5. The responsive process 500 is unique to the “add on” vetting selection. In a step 505, the details corresponding to the accepted original order are displayed and the user is prompted to enter an additional order and accompanying order details. Based on the original order requested, particular additional radiological examinations may be recommended to the user, such as by displaying them in a drop-down menu. The recommended add-on exams may be generated from a configurable client-defined database. In a step 510, one or more additional orders are received, stored in the vetting queue, flagged as having an approved vetting status, and flagged as ready for scheduling. Such additional orders are automatically deemed approved and ready for scheduling because the radiologist entered these orders. The order details received in step 510 can include, for example, patient identification information, ordering physician identification information, a date and time stamp, the type of radiological procedure, a reason for the exam, comments, and other information associated with the exam. Information from the original exam, such as patient identification information, can optionally automatically be copied into the details form for the new exam.

After the one or more additional radiology orders is received, the system prompts the user for a scheduling timeframe and receives a scheduling window for the one or more additional orders in a step 515. The scheduling window designates a timeframe for the radiological examination. In the alternative, a definite appointment time can be received. The original exam and one or more additional exams can be given the same window or time or they can be given different windows or times. In a step 520, the system automatically transmits a notification to the physician who ordered the examination. For example, the notification can take the form of an electronic message that is transmitted to the ordering physician's inbox in an electronic healthcare system. The notification can be by other electronic means such as through a portable wireless communication device. The contents of the notification can include the fact that the original order has been approved and that additional orders have been added. The notification can also include details associated with the original and additional orders, such as patient identification information, the type of radiological procedure, a date and time stamp indicative of when the original order was approved and when the additional one or more orders was added, the identity of the radiologist or healthcare professional that approved and added on to the order, an explanation of why one or more orders was added, and other comments associated with the vetting action taken. Upon receipt of the automatic notification, the ordering physician may still cancel any modified orders, but if the ordering physician takes no action, any additional orders received from the radiologist can be carried out. The system will not prevent these orders from being carried out. In a step 525, the original order is removed from the queue of unapproved radiology orders. In a step 530, the computer system determines whether the original order and any additional orders are of a type that is schedulable by comparing the order type to a configurable client-defined database of schedulable orders. If the particular order is not schedulable, then the process ends in a step 540 and the original approved procedure can be carried out. If the particular order is schedulable, then, in a step 535, the particular approved order is transmitted to a scheduler. The scheduling can be carried out through functionality provided by software operating in an electronic healthcare system. For example, the Scheduling Management solution marketed by the Cerner Corporation of Kansas City, Mo. may be used. In a step 545, the process ends and the user can address other pending orders.

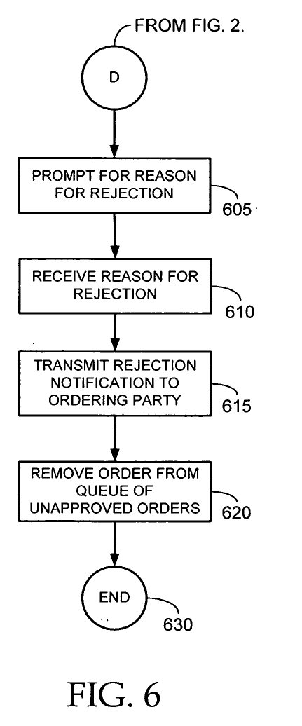

In a step 250, if the radiologist enters a “cancel” vetting selection, a command to reject a radiology order is received, the order is flagged as cancelled, and a responsive process 600 is performed, as depicted in FIG. 6. The responsive process 600 is unique to the “cancel” vetting selection in this embodiment. In a step 605, the details of the radiology order are displayed and the user is prompted for a reason for rejecting the order. In a step 610, a reason for the rejection is received. For example, the radiologist may determine that the ordering physician did not provide an appropriate or sufficient reason to justify the exam. In a step 615, the system automatically transmits a notification to the ordering physician. The notification can take the form of, for example, an electronic mail message that is transmitted to and appears in the physician's inbox. As discussed in detail below, FIGS. 8-9 display exemplary user interfaces for such an electronic notification of a cancelled radiology order. The notification could be by other electronic means, such as through a portable wireless communication device. The contents of the electronic notification can include, for example, the fact that the order has been rejected, the reason for the rejection, patient and ordering physician identification, the type of procedure requested, a date and time stamp indicating when the order was cancelled, and other comments associated with the vetting action taken. In a step 620, the order is removed from the queue of unapproved radiology orders. In a step 630, the process ends and the user can address other pending orders.

As displayed in FIG. 7, an exemplary embodiment of a user interface 700 of the present invention includes a graphical vetting tab 705. When a vetting tab 705 is selected by the user, a series of attributes 710A-F are displayed for each radiology order occurrence 715. The occurrences appearing in a vetting tab 705 can be configured by the user selecting an attribute column 710A-F. This allows the user to arrange the occurrences by attribute. For example, the user can view radiology orders arranged by patient name by selecting an attribute column 710B corresponding to “patient name.” This allows the user to view all of the radiology orders for a particular patient. The user can also, for example, arrange orders by their vetting status by selecting a vetting status attribute column 710E. The orders in a vetting tab 705 can be arranged by any attribute in descending or ascending order by the user selecting an attribute column 710A-F either one time or multiple times. If the user selects the selection region 720, the vetting tab 705 will display all orders, including those for which a vetting selection has been received already. If the user deselects the selection region 720, the vetting tab 705 will only display those orders for which a vetting selection has not yet been received, which provides the user an indication of orders requiring a vetting action. Configurable filters 725A-D can be applied to the database containing all radiology orders. For example, by selecting a date filter 725A, only radiology orders received on that particular date are displayed in a vetting tab 705. Other configurable filters can be applied to configure which radiology orders are displayed in a vetting tab 705. For example, by selecting a department filter 725B, only radiology orders corresponding to a particular department are displayed in a vetting tab 705. By selecting a section filter 725C, only radiology orders corresponding to a particular section are displayed in a vetting tab 705. By selecting a subsection filter 725D, only radiology orders corresponding to a particular subsection are displayed in a vetting tab 705. Vetting selection regions 730A-D display possible vetting selections that can be received from the user. For example, in an exemplary user interface 700, a vetting selection of “accept” can be selected to approve a radiology order occurrence 715 by a user selecting a vetting selection region 730A. Vetting selection regions 730A-D correspond to commands 235-250 of FIG. 2, which were discussed above. If a user selects a selection region 735, all of the details associated with a radiology order occurrence 715 can be displayed.

If a vetting selection of “cancel” is received, such as in a step 250, a responsive process 600 includes a step 615 of automatically notifying the ordering physician of the cancelled radiology order. FIG. 8 shows an exemplary embodiment of a user interface 800 of a physician inbox display region 805 containing a message occurrence 810 indicative of such a cancellation notification. Message occurrences 810 can be arranged within physician inbox display 805 according to message attributes 815. The contents of a cancellation. message occurrence 810 can be displayed in a user interface 900, as shown in FIG. 9 by the user selecting the message from the physician inbox display 805. As shown in FIG. 9, a user interface 900 displays text 905 of the message notifying the ordering physician of the cancellation. Text 905 of the message can include details associated with the cancelled order, such as, for example, the type of radiological examination requested, the reason for the cancellation, the date and time of the cancellation, the identity of the radiologist who made the cancellation, and accompanying comments. If vetting selections of “replace” or “add on” are received, such as in a step 240 or step 245, respectively, then a similar user interface is used to notify the ordering physician of the particular vetting action taken by the radiologist.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations This is contemplated by and within the scope of the claims.

What is claimed is:

1. A method for handling radiology orders in a computing environment, the method comprising:
receiving a radiology order;
storing the order in a queue of unapproved radiology orders;
receiving a vetting selection from the user;
performing a responsive process unique to the vetting selection; and
removing the order from the queue.

2. The method of claim 1, wherein the vetting selection received is a command to approve the radiology order.

3. The method of claim 2, wherein the responsive process comprises:
displaying the details of the radiology order; and
receiving a scheduling timeframe.

4. The method of claim 1, wherein the vetting selection received is a command to replace the radiology order with a new radiology order.

5. The method of claim 4, wherein the responsive process comprises:
displaying the details of the radiology order;
receiving a replacement radiology order;
receiving a scheduling timeframe; and
automatically notifying the ordering physician of the replacement order.

6. The method of claim 1, wherein the vetting selection received is a command to add an additional radiology order.

7. The method of claim 6, wherein the responsive process comprises:
displaying the details of the radiology order;
receiving an additional radiology order;
receiving a scheduling timeframe; and
automatically notifying the ordering physician of the additional order.

8. The method of claim 1, wherein the vetting selection received is a command to reject the radiology order.

9. The method of claim 8, wherein the responsive process comprises:
displaying the details of the radiology order;
prompting the user for a reason for rejecting the order;
receiving the reason; and
automatically notifying the ordering physician of the cancellation and the reason for the rejection.

10. One or more computer readable media having computer executable instructions for performing the method recited in any one of claims 1-9.

11. A user interface embodied on one or more computer readable media, the user interface comprising a display showing:
at least one radiology order occurrence;
for each radiology order occurrence, details associated with that radiology order occurrence; and
for each radiology order occurrence, a vetting status display area configured to display the status of the radiology order occurrence.

12. The user interface of claim 11, wherein the display further comprises one or more selection regions for receiving vetting commands.

13. The user interface of claim 11, wherein the display further comprises:
a selection region for receiving a command to approve a radiology order;
a selection region for receiving a command to replace a radiology order with a new radiology order;
a selection region for receiving a command to add an additional radiology order; and
a selection region for receiving a command to reject a radiology order.

14. The user interface of claim 11, wherein the display shows the status of a particular order as not vetted.

15. The user interface of claim 11, wherein the display shows the status of a particular order as accepted.

16. The user interface of claim 11, wherein the display shows the status of a particular order as cancelled.

17. A computerized system for handling radiology orders, the system comprising:
an order receiving component operative to receive a radiology order;
a storage component operative to store unapproved radiology orders in a queue;
a vetting selection receiving component operative to receive a vetting selection from the user;
a processing component operative to perform a responsive process unique to the vetting selection; and
a storage component operative to store an archive of radiology orders and details associated with said orders.

18. The system of claim 17, wherein the vetting selection made is a command to approve the radiology order.

19. The system of claim 18, wherein the responsive process comprises:
displaying the details of the radiology order; and
receiving a scheduling timeframe.

20. The system of claim 17, wherein the vetting selection made is a command to replace the radiology order with a new radiology order.

21. The system of claim 20, wherein the responsive process comprises:
displaying the details of the radiology order;
receiving a replacement radiology order;
receiving a scheduling timeframe; and
automatically notifying the ordering physician of the replacement order.

22. The system of claim 17, wherein the vetting selection made is a command to add an additional radiology order.

23. The system of claim 22, wherein the responsive process comprises:
displaying the details of the radiology order;
receiving an additional radiology order;
receiving a scheduling timeframe; and
automatically notifying the ordering physician of the additional order.

24. The system of claim 17, wherein the vetting selection made is a command to reject the radiology order.

25. The system of claim 24, wherein the responsive process comprises:
displaying the details of the radiology order;
prompting the user for a reason for rejecting the order;
receiving the reason; and
automatically notifying the ordering physician of the cancellation and the reason for the rejection.
